(19) United States
(12) Patent Application Publication
(10) Pub. No.: US 2010/0197236 A1
(43) Pub. Date: Aug. 5, 2010

(54) COMMUNICATION TERMINAL AND DEVICE CONNECTION AVAILABILITY DETERMINING METHOD

(75) Inventor: Akira Kawamura, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/667,006

(22) PCT Filed: Jul. 2, 2007
(86) PCT No.: PCT/JP2007/063233

§ 371 Date: Dec. 28, 2009

(51) Int. Cl. H04B 17/00

(52) U.S. Cl. 455/67.7

(57) ABSTRACT

An object of the present invention is to provide a communication terminal and a device connection availability determining method in which listing of information according to a neighboring wireless network is enabled to allow an operation of quickly and easily selecting target information. When a list of devices which are candidates of a connection destination is displayed, a network matching either a network identifier acquired by searching for a wireless network or an identifier of a belonging network is a network existing in the neighborhood of a location where the communication terminal is then located, and device information stored in association with its network identifier can be determined to be a device available in that location. Based on this determination, devices available and unavailable in that location are displayed in different modes so as to be identified by a user.

### TECHNICAL FIELD

The present invention relates to a communication terminal which connects to a communication device via a network and refers to information on the communication device and a device connection availability determining method in the communication terminal, and more particularly, to a communication terminal which searches for a server unit that stores content, selects and determines a connection destination from a search result thereof, acquires a list of the content stored in the server unit, and selects content as an operation target and a device connection availability determining method in the communication terminal.

### BACKGROUND ART

Currently, home information appliances having a function of mutually connecting devices via a network and sharing content stored in the device have been developed. In such appliances, one device functions as a server that provides content, while the other functions as a client that views the content on the server. Moreover, not only limited to viewing, but also various operations such as downloading, uploading, deleting, and editing of the content are possible from the client to the server.

As one scheme for realizing such content sharing between devices, DLNA (Digital Living Network Alliance) has drawn up guidelines. Examples of information and communications equipment in compliance with DLNA guidelines include PCs (Personal Computers), hard disk recorders, and digital televisions. In the future, the spread of devices having such functions is expected also in digital cameras and mobile devices such as mobile telephones. By mutual communication of such communications equipment, a home network will be built in a home.

FIG. 9 shows a general configuration of a home network. As shown in the figure, in the home network 100a including a communication terminal, the communication terminal 101a belongs to a wireless network formed by a wireless access point 102a. The wireless access point 102a is further connected with a communication device 103a and a communication device 104a. In the home network 100a thus configured, the communication terminal 101a searches for the communication device 103a and the communication device 104a via the wireless access point 102a, and displays information concerning the found devices on its display section 105a. Then, as a result of a connection destination being selected by a user, the communication terminal 101a determines a connection destination.

Here, when it is assumed that a connection destination is determined on the communication device 103a, the communication terminal 101a connects to the communication device 103a, acquires a content list composed of meta-information of content stored in the communication device 103a, and displays the content list on the display section 105a. Next, as a result of a desired content being selected in the communication terminal 101a, the communication terminal 101a performs operation such as acquisition of content data from the communication device 103a.

FIG. 10 is a sequence diagram showing operation of a publicly known home network. As shown in the figure, a communication terminal 201a multicast-transmits a search request message (S1001) to search for communication devices on the network. A communication device 204a and a communication device 205a having received the search request message transmit, to the communication terminal 201a being a sender of the search request message, a search response message in a certain time provided as a search completion time (S1002). The communication terminal 201a, as a result of receiving the search response message, can detect the existence of the communication device 204a and the communion device 205a. Because the search response message contains only minimum information such as an identifier unique to the device, the communication terminal 201a having received the response message transmits a device information acquisition request (S1003) to acquire further detailed information, and acquires device information (S1004) transmitted as a response thereto. The device information includes, for example, a device name and a list of functions to be provided by the device.

Subsequently, an operation to determine a connection destination device is performed by a user of the communication terminal 201a (S1005). In this case, when it is assumed that the connection destination is determined on the communication device 204a, the communication terminal 201a transmits a content list acquisition request (S1006), and acquires a content list as a response thereto (S1007). As a result of processing a series of these sequences, the communication terminal 201a learns information on each device on the network and information on content stored in the device.

As described above, for selecting a connection destination, although it is necessary to acquire device information besides searching for devices and receiving a response, an electronic device that, by storing device information in advance and displaying the stored device information as a list of connectable devices, allows performing a quick and easy device selection has been proposed (refer to, for example, Patent Document 1).

Moreover, when an operation such as acquisition of content on a device is performed, although it is necessary to take steps of searching for and determining a device of a connection destination and then acquiring a content list, there has been proposed an information management system that, by holding information about the content that has once been an operation target as a history, allows referring to a content list without connecting to the device (refer to, for example, Patent Document 2).

Patent Document 1: JP-A-2005-109745

Patent Document 2: JP-A-2006-227843

### DISCLOSURE OF THE INVENTION

### Problem to be Solved by the Invention

However, with the electronic device disclosed in Patent Document 1, when this electronic device is moved to various locations and used, it stores information on devices in various locations. Then, when a list of the stored information is displayed, a list of all devices including devices not in the neighborhood of that location and thus non-connectable is displayed. In such a case, a user is forced to choose a connectable device from the list, so that there is a problem that operability for the user is lowered.

Also in the information management system disclosed in Patent Document 2, there is the same problem as that of the electronic device disclosed in Patent Document 1. That is, in the information management system disclosed in Patent Document 2, when a communication terminal is used across a plurality of different networks, a meta-information list to be generated includes meta-information of content stored in the respective devices on different networks. In that case, because a list of meta-information including content on devices non-connectable in that location is displayed, a user is forced to choose available content from the list, so that operability for the user is lowered.

The present invention has been made in view of such circumstances, and an object thereof is to provide a communication terminal and a device connection availability determining method that can quickly and easily acquire available information in various locations.

### Means for Solving the Problem

A communication terminal according to the present invention comprises: a wireless network searching unit that is adapted to search for a surrounding wireless network; a communication unit that is adapted to belong to the wireless network to perform communication with a device; a device information acquiring unit that is adapted to acquire device information concerning the device via the communication unit; a device information storing unit that is adapted to store a network identifier of the belonging wireless network in association with the device information acquired by the device information acquiring unit; and a device access determining unit, with regard to the device information stored in the device information storing unit, determines to be accessible to the device when a first network identifier stored in association with the device information matches a second network identifier acquired from the wireless network searching unit or a third network identifier being an identifier of the belonging network.

According to this configuration, device information concerning a device and a network identifier of a wireless network to which the communication terminal belongs to when the device information is acquired are stored in the device information storing unit in association with each other. Further, a network matching either a network identifier acquired by the wireless network searching unit or an identifier of the belonging network when a list of devices which are candidates of a connection destination is displayed is a network existing in the neighborhood of a location where the communication terminal is then located, so that device information stored in the device identifier storing unit in association with its network information can be determined to be a device available in that location. Thus, based on that determination, devices available and unavailable in that location can be distinguished by a user.

In the above configuration, the communication terminal comprises: a display unit that is adapted to display a list of device information; and a display control unit that is adapted to perform control so as to display device information of a device determined to be accessible by the device determining unit in a first mode, and performs control so as to display a device not determined to be accessible by the device determining unit in a second mode.

According to this configuration, when a list of device information is displayed, device information of a device determined to be accessible is displayed in the first mode, and device information of a device determined to be inaccessible is displayed in the second mode, so that a user can clearly distinguish available and unavailable devices.

In the above configuration, the communication terminal comprises: a display unit that is adapted to display a list of device information; and a display control unit that is adapted to perform control, when displaying device information, so as to display as additional information the network identifier stored in association with the device information by the device information storing unit.

According to this configuration, when a list of device information is displayed, a network identifier being in association with the device information is displayed as additional information, so that a user can grasp not only device information but also a network identifier made in association with the device information.

In the above configuration, the communication terminal comprises: a display unit that is adapted to display a list of device information; and a display control unit that is adapted to perform control so as to sort each piece of device information to be displayed by a network identifier stored in association with the device information by the device information storing unit, and display the device information identifiably.

According to this configuration, when a list of device information is displayed, the device information is displayed sorted by a network identifier made in association with each piece of device information, so that a user can easily identify each piece of device information.

In the above configuration, the communication terminal comprises: a content information acquiring unit that is adapted to acquire content information concerning content stored in a device via the communication unit; a content information storing unit that is adapted to store content information acquired by the content information acquiring unit in association with device information acquired by the device information acquiring unit; and a content determining unit that is adapted to, with regard to content information stored in the content information storing unit, determines to be accessible to the content when a device corresponding to device information stored in association with the content information is determined to be accessible by the device access determining unit.

According to this configuration, content information and device information are acquired from a device, the acquired content information and device information are stored in the content information storing unit in association with each other, and if a device of device information stored in the content information storing unit is accessible, it is determined to be accessible to a content based on content information being in association with the device information, so that device information of a device that is accessible allows accessing content based on content information made in association with the device information.

In the above configuration, the communication terminal comprises: a display unit that is adapted to display a list of content information; and a display control unit that is adapted to perform control so as to display content information of content determined to be accessible by the content determining unit in a first mode, and performs control so as to display content information of content not determined to be accessible by the content determining unit in a second mode.

According to this configuration, when a list of content information is displayed, content information of a content determined to be accessible is displayed in the first mode, and content information of a content determined to be inaccessible is displayed in the second mode, so that a user can clearly distinguish available and unavailable content.

In the above configuration, the communication terminal comprises: a display unit that is adapted to display a list of content information; and a display control unit that is adapted to perform control, when displaying content information, so as to refer to device information stored in association with the content information by the content information storing unit, and display as additional information of the content information the network identifier stored in association with the device information by the device information storing unit.

According to this configuration, when a list of content information is displayed, via device information being in association with the content information, a network identifier being in association with the device information is displayed as additional information of the content information, so that a user can grasp not only content information but also a network identifier made in association with the content information.

In the above configuration, the communication terminal comprises: a display unit that is adapted to display a list of content information; and a display control unit that is adapted to perform control so as to identifiably display each piece of content information to be displayed by referring to device information stored in association with the corresponding content information by the content information storing unit, and by sorting the content information by a network identifier stored in association with the device information by the device information storing unit.

According to this configuration, when a list of content information is displayed, device information being in association with each piece of content information is referred to, the content information is sorted by a network identifier stored in association with the device information, and displayed identifiably, so that a user can easily identify each piece of content information.

In the above configuration, the communication terminal comprises a selecting unit that is adapted to instruct to select content information from a list, and the communication terminal, when arbitrary content information is selected by the selecting unit, refers to device information associated with the content information from the content information storing unit, refers to a network identifier associated with the device information from the device information storing unit, and automatically belongs to a wireless network indicated by the network identifier.

According to this construction, by selecting arbitrary content information from a list of content information, the communication terminal automatically belongs, via device information made in association with the selected content information, to a wireless network indicated by a network identifier made in association with the device information.

In the above configuration, the communication terminal comprises: a device searching unit that is adapted to perform a device search via the communication unit; and a control packet transmitting unit that is adapted to refer to, of device information stored in the device information storing unit in association with a belonging network identifier, device information of a device that has not been detected by the device searching unit, and transmits a control packet instructing start-up, to an address indicating the device information.

According to this configuration, a control packet instructing start-up is transmitted to an address indicated by device information of a device that has not been detected in a device search, so that a device with said address can be started.

A device connection availability determining method according to the present invention is a method in a computer having a wireless communication function, the method comprising: a wireless network searching step of searching for a surrounding wireless network; a belonging step of belonging to the wireless network; a device information acquiring step of connecting to a device by wireless communication, and acquiring information concerning the device; a second wireless network searching step of storing, in advance, device information by a device information storing step of storing, in a memory unit, a network identifier of the belonging wireless network in association with device information acquired by the device information acquiring step, and searching for a surrounding wireless network when displaying device information; and a device determining step of determining, with regard to device information stored in the device information storing step, whether a first network identifier stored in association with the device information matches a second network identifier acquired in the second wireless network searching step or a third network identifier being an identifier of the belonging network.

According to this method, device information concerning a device and a network identifier of a wireless network to which the communication terminal belongs to when the device information is acquired are stored in the device information storing unit in association with each other. Further, a network matching either a network identifier acquired by the wireless network searching unit or an identifier of the belonging network when a list of devices which are candidates of a connection destination is displayed is a network existing in the neighborhood of a location where the communication terminal is then located, so that device information stored in the device information storing unit in association with its network identifier can be determined to be a device available in that location. Thus, based on that determination, devices available and unavailable in that location can be distinguished by a user.

### Advantageous Effects of the Invention

The present invention, in a communication terminal which searches for a server unit that stores content, selects and determines a connection destination from a search result thereof, acquires a list of the content stored in the server unit, and selects content to be operated and a device connection availability determining method in the communication terminal, allows providing information available in that location quickly and easily.

### BRIEF DESCRIPTION OF THE DRAWINGS

FIG. 1 is a block diagram showing a schematic configuration of a home network according to an embodiment of the present invention.

FIG. 2 is a sequence diagram showing, among operations of the home network according to the embodiment of the present invention, an operation of recording acquired information.

FIG. 3 is a table view showing device information data to be recorded.

FIG. 4 is a table view showing content information data to be recorded.

FIG. 5 is a sequence diagram showing, among operations of the home network according to the embodiment of the present invention, an operation of displaying a list using recorded information.

FIG. 6 shows screen display examples of listing performed using recorded information.

FIG. 7 is a configuration view showing a configuration of a home network where a plurality of network areas are overlapping.

FIG. 8 is a sequence diagram showing, among operations of the home network according to the above-mentioned embodiment of the present invention, an operation of a power-on control of a communication device.

FIG. 9 is a configuration view showing a configuration of a general home network.

FIG. 10 is a sequence diagram for explaining a problem of a conventional home network.

Description of Reference Numerals and Signs

| | |
|---|---|
| 1, 2, 3, 4, 5 | Device |
| 9 | Home network |
| 10 | Communication terminal |
| 20, 20-1, 20-2 | Access point |
| 30, 30-1, 30-2 | Server unit |
| 101 | Operation input section |
| 102 | Control unit |
| 103 | Communication section |
| 104 | Display section |
| 105 | Network information storage section |
| 106 | Device information storage section |
| 107 | Content information storage section |
| 201 | Wireless communication section |
| 202 | Wired communication section |
| 301 | Communication section |
| 302 | Control unit |
| 303 | Content list generating section |
| 304 | Content list holding section |
| 701 | Network A |
| 702 | Network B |
| 1021 | Network control unit |
| 1022 | Device searching section |
| 1023 | Content information acquiring section |
| 1024 | Recorded information generating section |
| 1025 | Content operation section |

### BEST MODES FOR CARRYING OUT THE INVENTION

Hereinafter, a preferred embodiment for carrying out the present invention will be described in detail with reference to the drawings.

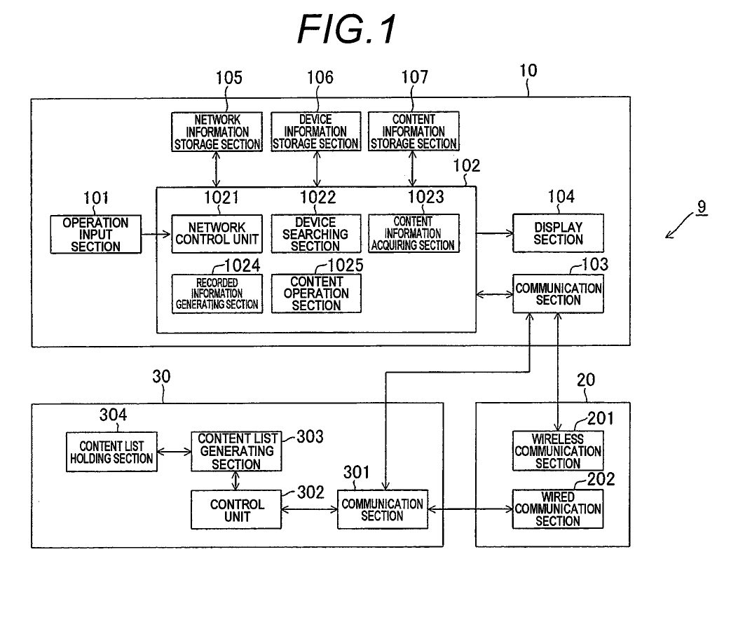

FIG. 1 is a block diagram showing a schematic configuration of a home network according to an embodiment of the present invention. In the figure, the home network 9 of the present embodiment is composed mainly of a communication terminal 10, an access point 20, and a server unit 30.

The communication terminal 10 is composed mainly of an operation input section 101, a control unit 102, a communication section 103, a display section 104, a network information storage section 105, a device information storage section 106, and a content information storage section 107. The control unit 102 includes a network control unit 1021, a device searching section 1022, a content information acquiring section 1023, a recorded information generating section 1024, and a content operation section 1025.

The operation input section 101 outputs, to the control unit 102, a network search request command, a network connection request command, a device search request command, a device selection request command, a recorded information reference command, and a content selection request command. The control unit 102 delegates the control to the internal network control unit 1021, device searching section 1022, content information acquiring section 1023, recorded information generating section 1024, and content operation section 1025 depending on the type of each request command from the operation input section 101. More specifically, when a network search request command and a network connection request command have been input, the control unit 102 delegates the control to the network control unit 1021. Alternatively, when a device search request command has been input, the control unit 102 delegates the control to the device searching section 1022. Alternatively, when a device selection request command has been input, the control unit 102 delegates the control to the content information acquiring section 1023. Alternatively, when a recorded information reference command has been input, the control unit 102 delegates the control to the recorded information generating section 1024. Alternatively, when a content selection request command has been input, the control unit 102 delegates the control to the content operation section 1025.

The network control unit 1021 instructs the communication section 103 to search a network in accordance with the network search request command from the operation input section 101. Moreover, as will be described later, when a network information list is input from the communication section 103, the network control unit 1021 inputs and displays a list of networks based on the content thereof on the display section 104 as well as inputs and stores the list of networks in the network information storage section 105. Further, the network control unit 1021 reads out corresponding network information from the network information storage section 105 in accordance with the network connection request command from the operation input section 101, and instructs the communication section 103 to belong to a network by use of the read-out network information. Then, the network control unit 1021 inputs and stores the network information used for the connection instruction in the network information storage section 105 as information on the belonging network.

The device searching section 1022 generates a device search message in accordance with the device search request command from the operation input section 101, and instructs the communication section 103 to transmit the device search message. Moreover, as will be described later, when a device search response message is input from the communication section 103, the device searching section 1022 inputs and displays device information based on the content thereof on the display section 104 as well as reads out a network identifier (a third network identifier) of the belonging network from the network information storage section 105, and inputs and stores the network identifier in association with the foregoing device information in the device information storage section 106.

The content information acquiring section 1023 reads out device information of a corresponding device from the device information storage section 106 in accordance with the device selection request command from the operation input section 101, generates a content list acquisition request message based on the read-out device information, and instructs the communication section 103 to transmit the generated content list acquisition request message. Moreover, as will be described later, when the content list acquisition response message output from the communication section 103 is input, the content information acquiring section 1023 acquires content information by interpreting the content thereof and inputs and displays the content information on the display section 104. At the same time, the content information acquiring section 1023 inputs and stores the device information previously read out from the device information storage section 106, in association with the content information, in the content information storage section 107.

The recorded information generating section 1024 acquires a list of the content information from the content information storage section 107 in accordance with the recorded information reference command from the operation input section 101, and inputs and displays the list on the display section 104.

The content operation section 1025 reads out corresponding content information from the content information storage section 107 in accordance with the content selection request command from the operation input section 101. The content operation section 1025 then reads out device information stored in association with the read-out content information from the device information storage section 106. The content operation section 1025 then reads out network information stored in association with the read-out device information and network information on the belonging network from the network information storage section 105, compares whether the two pieces of network information match each other, and if they match, generates an operation message for the foregoing content information, and controls the communication section 103 so as to transmit the operation message to a destination indicated by the foregoing device information. Alternatively, if the two pieces of network information do not match each other, the content operation section 1025 instructs the communication section 103 to belong to a network by use of network information stored in association with the foregoing device information, then generates an operation message for the foregoing content information, and controls the communication section 103 so as to transmit the operation message to a destination indicated by the foregoing device information.

The communication section 103, when being instructed by the network control unit 1021 to search a network, transmits a probe request. The probe request, which is transmitted a broadcast with no particular address designation, is received, when the access point 20 is located within a transmission area, by a wireless communication section 201 of the access point 20. Moreover, the communication section 103 receives a probe response transmitted from the wireless communication section 201 of the access point 20, generates a network information list from network information contained in the probe response, and outputs the network information list to the network control unit 1021. Moreover, the communication section 103, when being instructed by the network control unit 1021 to belong to a network, performs a connection process with the wireless communication section 201 of the access point 20 to establish a communication link.

Here, the communication section 103 and a communication section 301 of the server unit 30 are not physically connected with each other, however, if the foregoing communication link is established, it can be regarded that the communication section 103 and the communication section 301 of the server unit 30 have established a logical communication link via the access point 20. In the following, description will be given assuming that the communication section 103 and the communication section 301 of the server unit 30 can mutually transmit and receive signals.

The communication section 103, when being instructed by the device searching section 1022 to transmit a device search message, multicast-transmits a device search message. The device search message is received by the communication section 301 of the server unit 30 as a result of the logical communication link. The communication section 103 receives the device search response message transmitted from the communication section 301 of the server unit 30, and inputs the device search response message to the device searching section 1022.

Further, the communication section 103, when being instructed to transmit a content list acquisition request message from the content information acquiring section 1023, transmits the message to the communication section 301 of the server unit 30. The communication section 103 then receives a content list acquisition response message transmitted as a response from the communication section 301, and inputs the received message to the content information acquiring section 1023. Moreover, the communication section 103, when being instructed to transmit a content operation request message from the content operation section 1025, transmits the message to the communication section 301 of the server unit 30.

The display section 104 displays various list information input by the network control unit 1021, the device searching section 1022, the content information acquiring section 1023, and the recorded information generating section 1024. The network information storage section 105 records network information input from the network control unit 1021, and when being instructed to read out information, outputs the recorded network information.

The device information storage section 106 stores network information and device information input from the device searching section 1022 in association with each other, and when being instructed to read out information using the device information as a key, outputs the device information and the network information in pairs. The content information storage section 107 stores the device information and content information input from the content information acquiring section 1023 in association with each other, and when being instructed to read out information using the content information as a key, outputs the content information and device information in pairs.

Next, the configuration of the access point 20 will be described. The access point 20 is composed mainly of a wireless communication section 201 and a wired communication section 202. The wireless communication section 201 receives a probe request transmitted from the communication section 103 of the communication terminal 10, and transmits as a response thereto a probe response including an identifier etc., of a wireless network formed by the access point 20. Moreover, the wireless communication section 201 transfers a message addressed to the server unit 30 transmitted from the communication section 103 of the communication terminal 10 to the wired communication section 202, and transmits a message addressed to the communication terminal 10 transferred from the wired communication section 202 to the communication section 103. The wired communication section 202 transmits a message addressed to the server unit 30 transferred from the wireless communication section 201 to the communication section 301, and transfers a message addressed to the communication terminal 10 received from the communication section 301 to the wireless communication section 201.

Next, the configuration of the server unit 30 will be described. The server unit 30 is composed mainly of a communication section 301, a control unit 302, a content list generating section 303, and a content holding section 304. The communication section 301 inputs a request for content list acquisition received from the communication section 103 of the communication terminal 10 to the control unit 302, and transmits a content list input from the control unit 302 to the communication terminal 10 to be described later.

The control unit 302 inputs a content list generation command to the content list generating section 303 based on a request for content list acquisition input from the communication section 301. The content list generating section 303 generates a content list indicating the details of content stored in the content holding section 304 in accordance with control by the control unit 302, and inputs the content list to the control unit 302. The content holding section 304 stores the details of a large number of content.

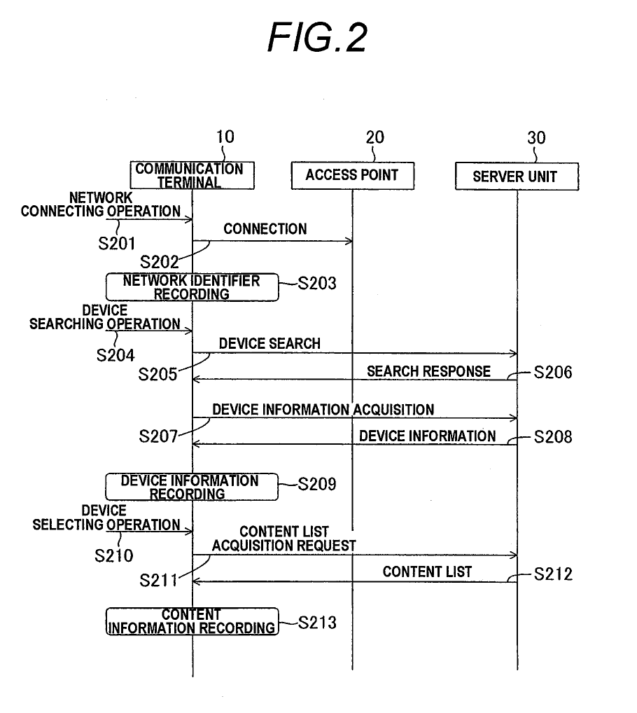

FIG. 2 is a sequence diagram showing operation of the home network 9. In the following, the operation of the home network 9 will be described based on FIG. 1 and FIG. 2. A user of the communication terminal 10 operates the operation input section 101, and the operation input section 101 inputs a network connection command to the network control unit 1021 (S201). It is assumed at this time that, information on a network that needs to be preferentially connected has already been stored in the network information storage section 105.

The network control unit 1021 reads out network information of a connection destination network from the network information storage section 105 in response to a network connection command from the operation input section 101, and instructs the communication section 103 to belong to a network. The communication section 103, when having received an instruction to belong to a network from the network control unit 1021, performs a connection process with the wireless communication section 201 of the access point 20 to establish a communication link (S202). When a communication link has been established, the network control unit 1021 then stores the previously read-out network information, as information on the belonging network, in the network information storage section 105 (S203).

Next, the user of the communication terminal 10 operates the operation input section 101, and the operation input section 101 inputs a device search request command to the device searching section 1022 (S204). The device searching section 1022 generates a device search message in response to the device search request command from the operation input section 101, and instructs the communication section 103 to transmit the message.

The communication section 103, when having received an instruction to transmit a device search message from the device searching section 1022, multicast-transmits the device search message (S205). Although this message is actually received by the wireless communication section 201 of the access point 20, because, as described above, a logical communication link has been established between the communication terminal 10 and the server unit 30, the device search message is received by the server unit 30.

The server unit 30, when having received a device search message from the communication section 103, generates and transmits a device search response message, and makes the communication section 103 of the communication terminal 10 receive the message (S206). The communication section 103, when having received the device search response message from the server unit 30, inputs the received device search response message to the device searching section 1022. The device searching section 1022, when having received the device search response message, generates a device information acquisition message to acquire further detailed information on a device, and instructs the communication section 103 to transmit the message.

The communication section 103, when having received the device information acquisition message from the device searching section 1022, transmits the received device information acquisition message to the server unit 30 (S207) to request transmission of device information. The server unit 30, when having received the device information acquisition request from the communication section 103, transmits its device information as a response (S208).

The communication section 103, when having received device information transmitted from the server unit 30, inputs the received message to the device searching section 1022. The device searching section 1022 interprets the message input from the communication section 103, inputs device information based on the content thereof to the display section 104 to display the device information. At the same time, the device searching section 1022 reads out network information of the belonging network from the network information storage section 105, and inputs and stores the network information, in association with the device information, in the device information storage section 106 (S209). A plurality of pieces of device information are stored in the device information storage section 106.

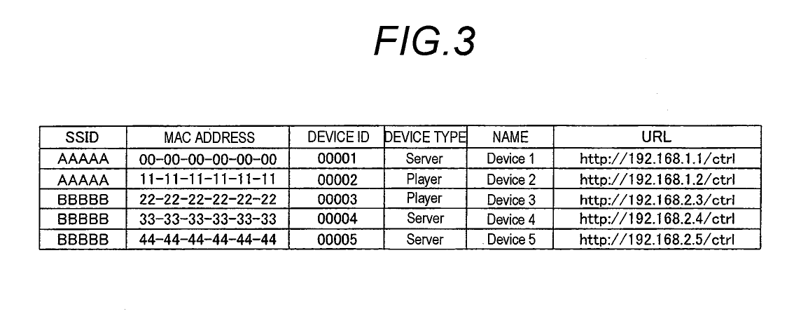

FIG. 3 is a table view showing an example of information to be stored in the device information storage section 106. When the wireless network is a wireless LAN (Local Area Network) provided by IEEE802.11, it is preferable to use, as network information, SSID (Service Set Identifier). Moreover, the information includes, device information, a MAC (Media Access Control) address allocated to a network interface of a device as a unique identifier, a device ID, a device type, a device name set so as to be easily understood by a user, and a destination URL (Uniform Resource Locator) of a control request such as a content list acquisition request. The device information storage section 106, having these as a set of information, stores information concerning a plurality of devices.

Returning to FIG. 2, next, the user of the communication terminal 10 operates the operation input section 101, and the operation input section 101 inputs a device selection request command to the content information acquiring section 1023 (S210). The content information acquiring section 1023 reads out corresponding device information from the device information storage section 106 in response to the device selection request command from the operation input section 101, generates a content list acquisition request message to a destination based on the content thereof, and instructs the communication section 103 to transmit the message. The communication section 103, when having received an instruction to transmit a content information acquisition request message from the content information acquiring section 1023, transmits the content information acquisition request message to the server unit 30 (S211).

The communication section 301 of the server unit 30, when having received the content information acquisition request message from the communication section 103, inputs the received content information acquisition request message to the control unit 302. The control unit 302, when having received the content list generation command from the communication section 301, inputs the command to the content list generating section 303. The content list generating section 303, when having received the content list generation command from the control unit 302, generates a content list indicating the details of content stored by the content holding section 304, and inputs the content list to the control unit 302. The control unit 302 generates a content information acquisition response message based on the content list input from a content list generating section 353, and inputs the message to the communication section 301. The communication section 301 transmits the content information acquisition response message input from the control unit 302, and makes the communication section 103 of the communication terminal 10 receive the message (S212).

The communication section 103, when having received the content information acquisition response message from the communication section 301, inputs the message to the content information acquiring section 1023. The content information acquiring section 1023 interprets the message input from the communication section 103, inputs content information based on the content thereof to the display section 104 to display the content information. At the same time, the content information acquiring section 1023 inputs and stores the content information, in association with the device information previously read out as a connection destination, in the content information storage section 107 (S213).

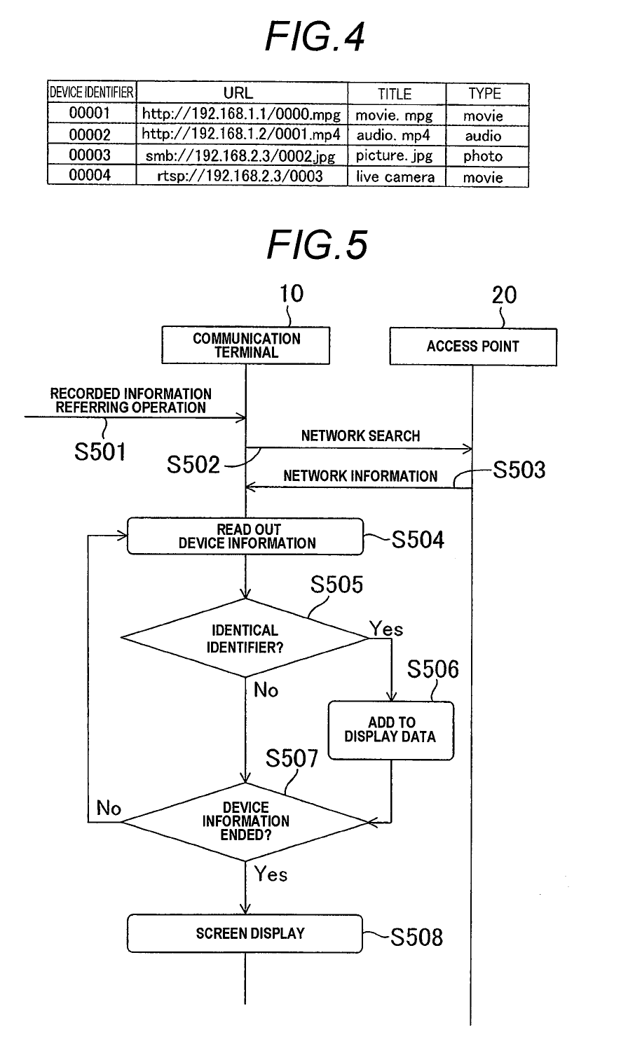

A plurality of pieces of content information are stored in the content information storage section 107. FIG. 4 is a table view showing an example of information to be stored in the content information storage section 107. Information on a piece of content is stored in association with a device ID to be associated with one entry of the device information in FIG. 2. The information on a piece of content includes a URL to acquire real data of content, a content title, and a content type. The content information storage section 107, having these as a set of information, stores information concerning a plurality of pieces of content. Thus, in the communication terminal 10, network identifiers, device information, and content information are stored indirectly associated with each other.

In the following, an operation sequence for performing, in the communication terminal 10, selection of a connectable communication device by a quick and easy operation will be described. FIG. 5 is a sequence diagram showing, among operations of the home network 9, in particular, an operation to cause a user to select a connection destination device based on stored device information. In the following, these operations will be described based on FIG. 1 and FIG. 5.

A user of the communication terminal 10 operates the operation input section 101, and the operation input section 101 inputs a recorded information reference command to the recorded information generating section 1024 (S501). The recorded information generating section 1024 requests the communication section 103 to search for a network in response to the recorded information reference command from the operation input section 101 (S502). This makes a probe request be transmitted by the communication section 103, and be received by the access point 20 or a communication device (not shown) disposed in the neighborhood.

The access point 20, when having received the probe request transmitted from the communication section 103 of the communication terminal 10, transmits a probe response to the communication terminal 10 (S503). This probe response is received by the communication section 103 of the communication terminal 10. The communication section 103, when having received the probe response, inputs network information including the network identifier to the recorded information generating section 1024. Here, description will be given assuming that the network identifier of the illustrated access point 20 is “BBBBB.” Although, in FIG. 1, only one access point is illustrated, as a matter of course, a plurality of access points can exist. In that case, a plurality of pieces of network information are input to the recorded information generating section 1024 in response to the number of probe responses to be received by the communication section 103.

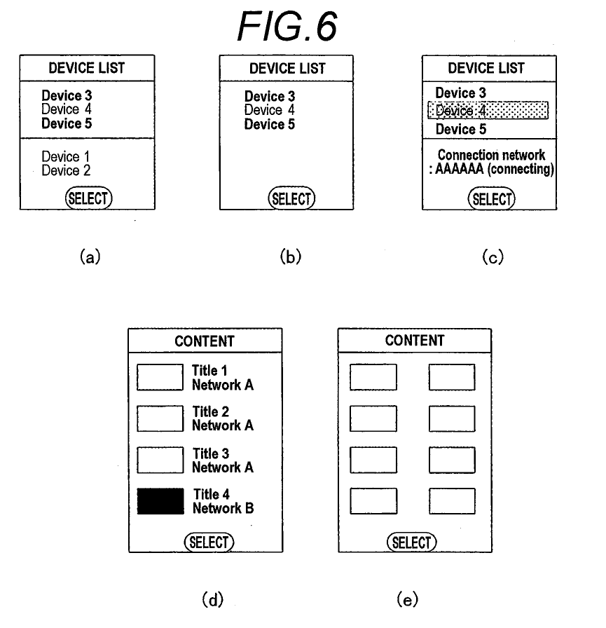

The recorded information generating section 1024, when having received network information including a network identifier from the communication section 103, generates display data for device listing. Although various modes of device listing can be considered, description will be given here of an example of performing a display as shown in (b) of FIG. 6. The example of (b) of FIG. 6 is an example of displaying only connectable devices when displaying a device list.

The recorded information generating section 1024 reads out registered network information and device information from the device information storage section 106. As described before, a plurality of pieces of device information can be registered in the device information storage section 106. Here, description will be given assuming that five pieces of device information as shown in FIG. 3 have been registered. As shown in FIG. 3, device information having a name of “Device 1,” “Device 2” has been associated with a network represented by SSID of “AAAAA,” and device information having a name of “Device 3,” “Device 4,” “Device 5” has been associated with a network represented by SSID of “BBBBB.”

The recorded information generating section 1024 reads out pairs of device information and network information from the device information storage section 106 one by one (S504). The recorded information generating section 1024 subsequently confirms whether a network identifier (a first network identifier) associated with the read-out device information matches a network identifier (a second network identifier) included in the network information previously input from the communication section 103 (S505). If they match, the recorded information generating section 1024 adds the device information to display data (S506), and if they do not match, the recorded information generating section 1024 does not add the device information to display data. Then, the recorded information generating section 1024 confirms whether unread device information has been registered in the device information storage section 106 (S507), and if unread device information remains, the operation returns again to the process of reading out the device information (S504) to repeat the same process. When having completed the confirmation of all device information, the recorded information generating section 1024 inputs the generated display data to the display section 104, and selectively displays a list of available devices to the user of the communication terminal 10 (S508).

Thus, it becomes possible to selectively display only a list of available devices, without performing a belonging process to an access point and a device searching process.

Although not illustrated in the sequence of FIG. 5, by, as described by using FIG. 1, performing a belonging process to the access point 20 and a device searching process after device listing, the information of the device information storage section 106 and the content of the display section 104 are updated. Although a description has been given here assuming that a list of only available devices is displayed, various modes of display can be considered. Examples thereof are mentioned as follows.

In (a) of FIG. 6, available devices are displayed at an upper position, and information on devices that are unavailable but have been recorded is displayed at a lower position. Further, a ruled line is displayed in the middle as a display to distinguish between the available devices and the unavailable devices. In (c) of FIG. 6, a list of available devices is displayed at an upper position, while information on a network belonging to which is necessary in order to use the devices is incidentally displayed at a lower position. This provides an effect of allowing a user to visually check information on a network belonging to which is necessary in order to use a device.

Further, a description has been given here of an example of displaying a list of device information, however, executing the same process for the content information recorded in the content information storage section 107 in place of the device information also enables displays of (e) and (f) of FIG. 6. In the display of (e) of FIG. 6, a title and a thumbnail are displayed as information on a piece of content, and information on a network belonging to which is necessary in order to use that content is also incidentally displayed. Further, that information is sorted and displayed for each network belonging to which is necessary. With regard to a piece of content that is unavailable in that location, changing the mode of display such as graying out provides an effect of allowing the user to distinguish between available and unavailable content at a glance.

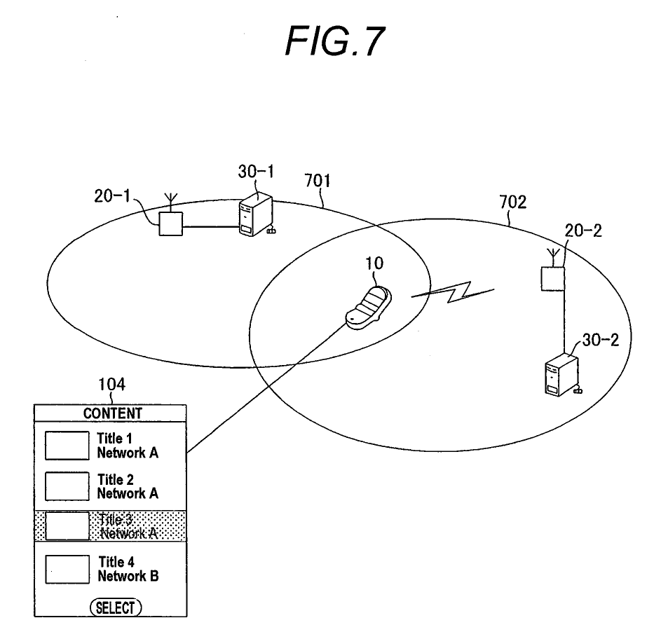

Moreover, when a communication terminal is located in an overlapping location of wireless areas formed by a plurality of wireless access points as shown in FIG. 7 other than such an environment as shown in FIG. 1, an operation of selecting from listed content information makes it also possible to switch between belonging wireless networks.

In FIG. 7, the communication terminal 10 is located in an area where a network A 701 and a network B 702 are overlapping with each other. In the display section 104 of the connection terminal 10, “Title 1” and “Title 2” that are content stored in a server unit 30-1 connected to an access point 20-1 of the network A 701 are displayed, and “Title 3” and “Title 4” that are content stored in a server unit 30-2 connected to an access point 20-2 of the network B 702 are displayed. For using the content “Title 3,” although it is necessary that the communication terminal 10 belongs to the network B 702, performing a process of automatically switching to belonging to the network B 702 when “Title 3” has been selected by the user makes the content available without requiring an operation of switching networks by the user.

However, as shown in (b) of FIG. 6, when a device list is displayed based on recorded device information, a difference from information on devices disposed in an actual network can possibly occur. For example, in (b) of FIG. 6, it is assumed that device listing is performed based on device information where “Device 3,” “Device 4,” and “Device 5” have been recorded. It is then assumed that, as a result of a device search being performed in parallel with the device listing, “Device 3” and “Device 5” have been found, while there was no response with regard to “Device 4” and “Device 4” has not been found. Based on this fact, in (b) of FIG. 6, “Device 4” is displayed grayed out (displayed in pale gray) in order to make valid device information distinguishable from possibly invalid device information.

Here, with regard to “Device 4” that has not been found, it can also be considered that the device has been removed from the network, however, on a home network where a stationary device is often disposed, it is highly likely that a device search response could not be acquired and the device was not found because the power has not been turned on. Therefore, when the device is not found in a wireless network associated with device information despite the storage of the device information, a packet instructing power-on of the device can be transmitted over the network.

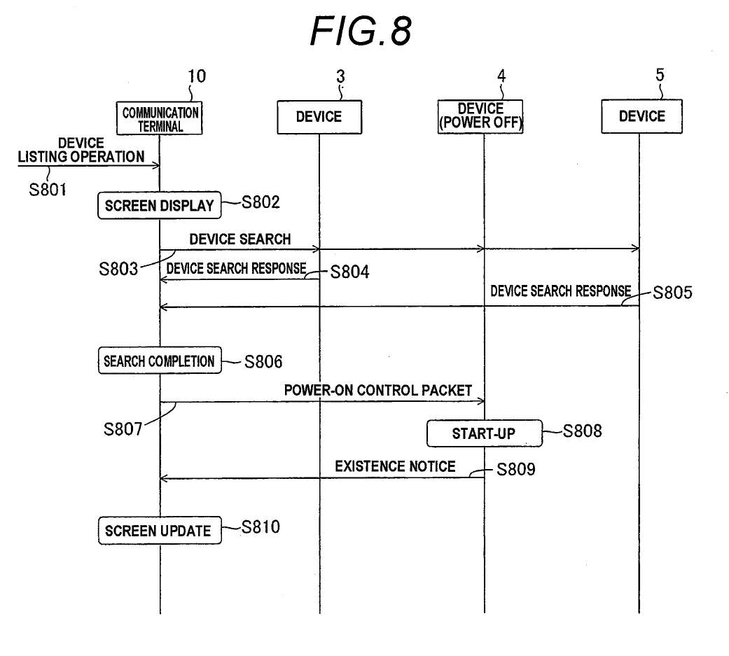

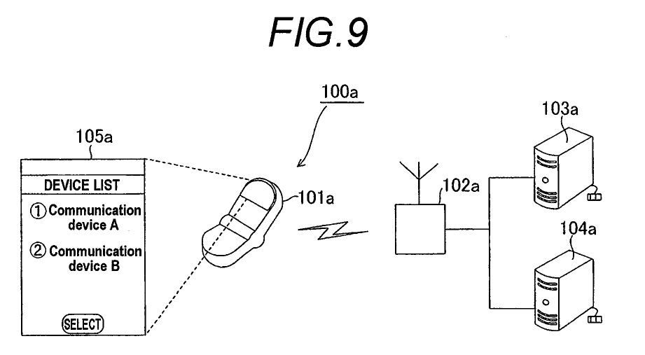

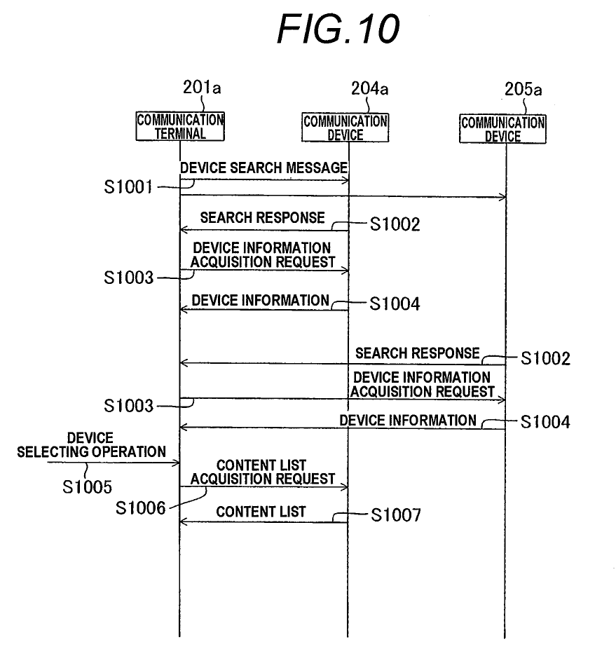

FIG. 8 is a sequence diagram showing a device search response and an operation when transmitting a power-on instruction packet based on recorded information. In the following, the sequence in such an example will be described based on FIG. 8. It is provided as a precondition for description that, in the communication terminal 10, device information of “Device 1” to “Device 5” have been already recorded as shown in FIG. 3, and “Device 3,” “Device 4,” and “Device 5” have been connected to a network to which the communication terminal 10 belongs. In this case, it is provided, however, that “Device 4” has not been powered on (that is, in an OFF state).

First, it is provided that an operation of displaying device listing is performed by a user of the communication terminal 10 (S801), and a list of devices according to a neighboring network state is displayed (S802). Because the details of the operation in this period are the same as those of the operation (S501 to S508) described by using FIG. 5, the description and illustration are omitted.

Next, when a screen display is completed, the communication terminal 10 again multicast-transmits a device search request message to confirm a difference between the recorded device information and the actual device state (S803).

Next, by the device 3 and the device 5 having received the device search request, a device search response message is transmitted addressed to the communication terminal 10 (S804 and S805). In this case, because the device 4 is in a power OFF state, a device search response is not transmitted from the device 4.

Next, in the communication terminal 10, after an elapse of a certain time provided as a search completion waiting time, it is determined that there is no response from the device 4 (S806). In this case, on a display screen of the communication terminal 10, it is desirable to perform a display, as shown in (b) of FIG. 6, such as graying out a device from which there is no response, for allowing a user to identify the device. Based on this fact, the wireless communication terminal 10 transmits a power-on control packet addressed to the device 4 (S807). The power-on control packet is, for example, a packet based on a known scheme such as Wake on LAN (registered trademark), and cannot be generally transmitted unless a destination MAC address is already known. In the present invention, because, as shown in FIG. 3, the MAC addresses have been stored in the terminal as device information, transmission of such a power-on control packet is enabled without being intended by the user.

Next, when the device 4 is started by the received power-on control packet (S808), the device 4 multicast-transmits an existence notice message for notifying of self-existence (S809). The information in this existence notice message includes information equivalent to the foregoing device search response.

Next, as a result of the communication terminal 10 receiving an existence notice from the device 4, it can be determined that the device 4 has become available, and thus updating the display screen so as to change, based on this fact, the display that has been grayed out to a normal display (S810) makes devices available at that point in time very obvious to the user, so that operability is improved. The above operation allows providing a communication terminal, which can automatically detect a device that has not been powered on and perform a power-on control, excellent in operability for a user.

Although, in the above description, a power-on control packet is designed to be transmitted, user's operation may trigger packet transmission.

Moreover, although, in the present embodiment, information on connected devices and content are designed to be automatically recorded in the terminal, an operation by a user may be added so as to record only information intended by the user.

Moreover, although the present invention has been described taking an example of a wireless network formed by wireless access points, the present invention can also be similarly carried out in an AdHoc network that is constructed by wireless devices.

While the present invention has been described in detail and with reference to a specific embodiment, it will be apparent to those skilled in the art that various changes and modifications may be made therein without departing from the spirit and scope of the present invention.

### INDUSTRIAL APPLICABILITY

The present invention can be applied to a wireless communication apparatus and the like with a function capable of connecting to a communication device by way of wireless.

1. A communication terminal comprising:
a wireless network searching unit that is adapted to search for a surrounding wireless network;
a communication unit that is adapted to belong to the wireless network to perform communication with a device;
a device information acquiring unit that is adapted to acquire device information concerning the device via the communication unit;
a device information storing unit that is adapted to store a network identifier of the belonging wireless network in association with the device information acquired by the device information acquiring unit; and
a device access determining unit, with regard to the device information stored in the device information storing unit, determines to be accessible to the device when a first network identifier stored in association with the device information matches a second network identifier acquired from the wireless network searching unit or a third network identifier being an identifier of the belonging network.

2. The communication terminal according to claim 1, comprising:
a display unit that is adapted to display a list of device information; and
a display control unit that is adapted to perform control so as to display device information of a device determined to be accessible by the device determining unit in a first mode, and performs control so as to display a device not determined to be accessible by the device determining unit in a second made.

3. The communication terminal according to claim 1, comprising:
a display unit that is adapted to display a list of device information; and
a display control unit that is adapted to perform control, when displaying device information, so as to display as additional information the network identifier stored in association with the device information by the device information storing unit.

4. The communication terminal according to claim 1, comprising:
a display unit that is adapted to display a list of device information; and
a display control unit that is adapted to perform control so as to sort each piece of device information to be displayed by a network identifier stored in association with the device information by the device information storing unit, and display the device information identifiably.

5. The communication terminal according to claim 1, comprising:
a content information acquiring unit that is adapted to acquire content information concerning content stored in a device via the communication unit:
a content information storing unit that is adapted to store content information acquired by the content information acquiring unit in association with device information acquired by the device information acquiring unit; and
a content determining unit that is adapted to, with regard to content information stored in the content information storing unit, determines to be accessible to the content when a device corresponding to device information stored in association with the content information is determined to be accessible by the device access determining unit.

6. The communication terminal according to claim 5, comprising:
a display unit that is adapted to display a list of content information; and
a display control unit that is adapted to perform control so as to display content information of content determined to be accessible by the content determining unit in a first mode, and performs control so as to display content information of content not determined to be accessible by the content determining unit in a second mode.

7. The communication terminal according to claim 5, comprising:
a display unit that is adapted to display a list of content information; and
a display control unit that is adapted to perform control, when displaying content information, so as to refer to device information stored in association with the content information by the content information storing unit, and display as additional information of the content information the network identifier stored in association with the device information by the device information storing unit.

8. The communication terminal according to claim 5, comprising:
a display unit that is adapted to display a list of content information; and
a display control unit that is adapted to perform control so as to identifiably display each piece of content information to be displayed by referring to device information stored in association with the corresponding content information by the content information storing unit, and by sorting the content information by a network identifier stored in association with the device information by the device information storing unit.

9. The communication terminal according to claim 6, comprising a selecting unit that is adapted to instruct to select content information from a list, wherein
the communication terminal, when arbitrary content information is selected by the selecting unit, refers to device information associated with the content information from the content information storing unit, refers to a network identifier associated with the device information from the device information storing unit, and automatically belongs to a wireless network indicated by the network identifier.

10. The communication terminal according to claim 1, comprising:
a device searching unit that is adapted to perform a device search via the communication unit; and
a control packet transmitting unit that is adapted to refer to, of device information stored in the device information storing unit in association with a belonging network identifier, device information of a device that has not been detected by the device searching unit, and transmits a control packet instructing start-up, to an address indicating the device information.

11. A device connection availability determining method in a computer having a wireless communication function, the method comprising:
a wireless network searching step of searching for a surrounding wireless network;
a belonging step of belonging to the wireless network;
a device information acquiring step of connecting to a device by wireless communication, and acquiring information concerning the device;
a second wireless network searching step of storing, in advance, device information by a device information storing step of storing, in a memory unit, a network identifier of the belonging wireless network in association with device information acquired by the device information acquiring step, and searching for a surrounding wireless network when displaying device information; and
a device determining step of determining, with regard to device information stored in the device information storing step, whether a first network identifier stored in association with the device information matches a second network identifier acquired in the second wireless network searching step or a third network identifier being an identifier of the belonging network.
